(19) United States
(12) Patent Application Publication
(10) Pub. No.: US 2005/0165939 A1
(43) Pub. Date: Jul. 28, 2005

(54) System, communication network and method for transmitting information

(75) Inventors: Joona Nikunen, Helsinki (FI); Harri Cederlof, Desmond (FI)

Correspondence Address: OLIFF & BERRIDGE, PLC, P.O. BOX 19928, ALEXANDRIA, VA, 22320, US

(73) Assignee: Metso Automation Oy, Helsinki (FI)

(21) Appl. No.: 10/513,719

(22) PCT Filed: May 26, 2003
(86) PCT No.: PCT/FI03/00403

(30) Foreign Application Priority Data
May 30, 2002 (FI) 20021020

(51) Int. Cl. G06F 15/173; G06F 15/16

(52) U.S. Cl. 709/230; 709/225

(57) ABSTRACT

The present invention relates to a system comprising: a process control network (3) having process equipment (2) connected thereto for receiving, through the process control network, control commands and for transmitting messages. To enable a high-security-level system to be achieved, wherein the state of a process can be established from an external communication network, the process control network (3) is connected to an external communication network (5) via a one-way data transfer device (12). The external communication network has storage equipment (6 to 8, 13) connected thereto, configured to store at least some of the information contained in the messages to be transmitted from the process control network (3) to the external communication network (5).

### FIELD OF THE INVENTION

The present invention relates to information security of a process control network, and particularly to a solution for ensuring that outsiders are incapable of affecting the operation of process equipment in the process control network. The concepts “process” and “process control network” should be understood broadly. In accordance with the invention, the network may be any communication network including actuators/process equipment for the operation of which it is important that no outsiders are capable of interfering with the operation of the equipment in the network.

### BACKGROUND OF THE INVENTION

Conventionally, process control networks have been implemented as closed networks having no external connections. Consequently, the risk of outside attacks has been eliminated.

However, recent advances in communication technology and the Internet, for example, have increased the pressure to provide access to information in a process control network also via external communication networks. An example of such an external communication network is an office network of an industrial plant, which may have a further connection e.g. to the Internet. The aim has been to enable various information on a process and/or process equipment to be retrieved also through an external communication network. Such information may concern e.g. a current state of the process and/or process equipment or e.g. the development of the state during certain periods of time, equipment operating parameters, event logs or control commands. However, a connection from a process control network to external communication networks causes considerable problems with information security. Current known information security solutions are usually based on using different firewalls for trying to ensure that no outsiders gain access to networks that are to be protected against outsiders. It seems, however, that hackers and various computer viruses have repeatedly succeeded in utilizing holes in information security in the firewalls.

Since undisturbed operation of a nuclear power plant, an industrial plant or a process control network e.g. on a ship is of extremely high importance, the known solutions based on firewalls are insufficient for achieving a necessary level in information security.

### SUMMARY OF THE INVENTION

An object of the invention is to solve the above-described problem and provide a solution which improves the security of a process control network without having to completely isolate the process control network from external communication networks. This object is achieved by the system of independent claim 1, communication equipment of dependent claim 7, and the method of independent claim 9.

The idea underlying the invention is that attacks of an outside attacker can be prevented efficiently by utilizing a one-way data transfer device which allows data to be transferred in messages from a protected network towards external networks but which prevents information and messages from being transmitted from an external network towards the protected network. As distinct from conventional firewalls, the invention thus utilizes a one-way data transfer device which does not even enable messages to be transmitted to a protected network. Consequently, an outsider has no chance of transmitting any kind of messages or commands to a protected process control network.

However, in order to enable inquiries to be made from an external network and information about a process and/or process equipment to be received as a response, the invention utilizes storage equipment connected to the external network for receiving messages from the protected process control network. The storage equipment stores at least some of the information in the messages in memory. Consequently, the most recent information describing the process collects to the storage equipment.

The most important advantage of the solution of the invention is thus that the one-way data transfer device enables the risk of harmful or damaging control commands being forwarded to the protected process control network to be eliminated in a completely reliable manner. However, thanks to the storage equipment, access to process information is still provided from external networks.

In a first preferred embodiment of the invention, storage equipment stores information contained in messages delivered from a process control network into a databank. The databank may then serve several computers. When access is to be gained from an external network to information describing a process, an inquiry message originating from a computer connected to the external communication network is conveyed to this databank, instead of allowing inquiry messages supplied from the external network to progress to the process control network. A user of the computer that transmitted the inquiry message does not even necessarily have to know that his or her inquiry never reached the process control network but only the storage equipment connected to the external network.

In a second preferred embodiment of the invention, the storage equipment may consist of a computer connected to an external communication network. In such a case, no centralized databank is needed but messages originating from a process control network may be assigned directly to a predetermined computer or computers, whereto information needed by users of the particular computers thus collects. In this solution, it is unnecessary for the users of the computers to transmit any inquiries since the process control network takes care that the information needed by the users automatically collects onto the computers they use.

In a third preferred embodiment of the invention, a one-way data transfer device or a firewall located between the data transfer device and a process control network is configured to automatically transmit an acknowledgement to the process control network when the data transfer device or, correspondingly, the firewall, has received a message to be transmitted to an external network. This embodiment enables e.g. commonly utilizable packet-switched data transfer protocols to be utilized in the process control network. Such protocols typically require that an acknowledgement be delivered from the receiver to the node which transmitted a package for indicating that the package was successfully received. This embodiment enables such an acknowledgement to be delivered in spite of using a one-way data transfer device preventing acknowledgements from being transmitted from an external network.

In a fourth preferred embodiment of the invention, messages being delivered to a one-way data transfer device or communication equipment including a one-way data transfer device in a first transfer direction, i.e. from a process control network, travel via a firewall. The firewall allows messages to progress through the firewall or, correspondingly, the firewall prevents messages from progressing therethrough in accordance with a predetermined filtering condition. This embodiment of the invention enables a user of the system to set a desired filtering condition such that not all messages are allowed to progress through the firewall.

Preferred embodiments of the system and communication equipment of the invention are disclosed in the attached dependent claims 2 to 6 and 8.

### BRIEF DESCRIPTION OF THE DRAWINGS

In the following, the invention will be described in closer detail by way of example and with reference to the accompanying drawings, in which

FIG. 1 is a flow diagram and FIG. 2 is a block diagram showing a first preferred embodiment of the invention,

FIG. 3 is a block diagram showing a second preferred embodiment of the invention,

FIG. 4 is a block diagram showing a third preferred embodiment of the invention,

FIG. 5 illustrates a preferred embodiment of a one-way data transfer device, and

FIG. 6 is a block diagram showing a fourth preferred embodiment of the invention.

### DESCRIPTION OF PREFERRED EMBODIMENTS

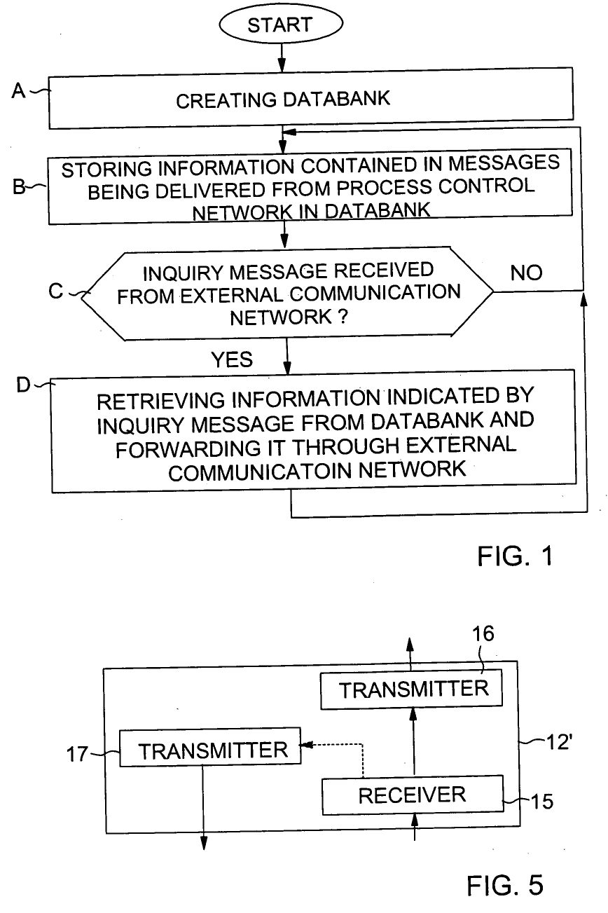

FIG. 1 is a flow diagram showing a first preferred embodiment of the invention.

Block A comprises generating a databank, .e.g. a database, which receives messages from a process control network via a one-way data transfer device. The databank is connected to an external communication network via which information can be retrieved from the databank.

Block B comprises storing information contained in messages being delivered from the process control network. Typically, the information is information describing the state of a process and process equipment.

Block C comprises checking whether an inquiry message has been received from the external communication network, a sender of the inquiry message aiming to gain information about the state of the process or the process equipment. If, in block C, an inquiry message has been received, block D comprises retrieving the information indicated by the inquiry message from the databank. In other words, instead of delivering an inquiry message to the actual process network, information is retrieved from a databank located outside the process control network. The information retrieved from the databank is forwarded through the external communication network.

The method of the flow diagram of FIG. 1 enables process information to be forwarded through the external network without such a procedure requiring inquiries to be made to the process control network. This is possible due to the created databank wherein all relevant information describing the process and process equipment can be stored in advance. The sender of the inquiry messages delivered through the external communication network does not even have to know that the response delivered to him or her was not actually supplied from the process control network but from storage equipment connected to an external communication network.

FIG. 2 is a block diagram showing a first preferred embodiment of the system of the invention whereto the method of FIG. 1 can be applied. A process 1 shown in FIG. 2 is monitored and controlled through process equipment 2. The process equipment 2 is connected to a process control network 3 via which control commands are delivered to the process equipment 2 and via which messages describing the state of the process are forwarded from the process equipment 2. A control terminal 4 of an operator is connected to the process control network for transmitting control commands to the process equipment 2 and for receiving messages describing the state of the process from the process equipment.

FIG. 2 also shows an external communication network 5, which may consist e.g. of an office network of an industrial plant. Computers 6 to 8 are thus connected to the external communication network 5. The external communication network may, as shown by FIG. 2, be connected to other communication networks, such as the Internet 10, via a firewall 9.

In the case of FIG. 2, the process control network 3 is connected to the external communication network 5 via a one-way data transfer device 12 included in communication equipment 11. The aim of the communication equipment 11 is to prevent control commands and other harmful messages from progressing from the external communication network 5 to the process control network and, at the same time, to enable e.g. a computer 6 connected to the external communication network 5 to be used for retrieving information describing the state of the process 1. Similarly, in the case of FIG. 2, information describing the state of the process 1 can be retrieved e.g. via a computer 18 connected to the Internet 10.

The one-way data transfer device 12 allows messages to be transmitted in a first direction from the process control network 3 towards the external communication network 5. Messages to be transmitted in a second direction, i.e. from the external communication network 5 to the process control network 3, are prevented from progressing through the one-way data transfer device 12. This helps preventing e.g. a hacker or a computer virus from causing damage in the process control network 3. In order to achieve a sufficient security level, the one-way data transfer device can be implemented e.g. as a device compiled using circuits, having no configuration potentiality or user interface. This is to ensure that users are incapable of even temporarily enabling the one-way data transfer device to allow messages to be transmitted also in the second transfer direction, i.e. from the external communication network 5 to the process control network 3, by modifying the settings.

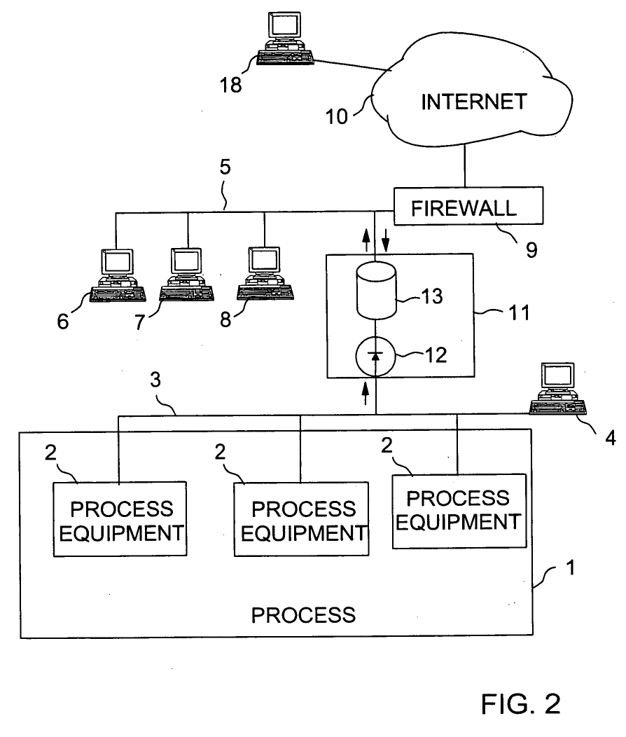

The communication equipment 11 also includes storage equipment 13 connected to the external communication network 5. The storage equipment monitors messages to be transmitted from the process control network 3 in the first direction towards the external communication network 5 and stores the information contained therein in a databank created in its memory. The information to be stored may consist of any data available from the process control network. Consequently, the information may e.g. describe the state of the process and/or process equipment at a certain moment or e.g. during a certain period of time. The information may also include reports produced by the control terminal 4 of an operator of the process control network. Each message received from the process control network thus contributes to the formation of a more complete description of the state of the process 1 in the databank. When, for example, a user of the computer 6 connected to the external communication network wishes to find out a piece of information describing the state of the process, the user transmits an inquiry message through the computer, the inquiry message then being conveyed to the storage equipment 13. The storage equipment which, in the case of FIG. 3, may consist e.g. of a server connected to an office network, then, in response to the inquiry message, retrieves the information indicated by the inquiry message from its memory and transmits the information to the computer 6 through the external communication network.

In the case of FIG. 2, messages to be transmitted from the process control network 3 to the external communication network 5 may originate directly from the process equipment 2. In such a case, the information contained therein may consist e.g. of measurement results describing a current state of the process. Such messages originating from the process equipment may originally be assigned directly to the storage equipment 13. Alternatively, the storage equipment 13 connected to the process control network via the one-way data transfer device 12 may be configured to monitor all messages to be transmitted in the process control network 3 and to store the information in all detected messages in its memory. In such a case, the process equipment 2 does not have to transmit messages to the storage equipment 13 in particular but the storage equipment is also capable of receiving and storing the information in messages to be transmitted e.g. from the process equipment 2 to the control terminal 4 of the operator. It is also conceivable that the operator, utilizing its control terminal 4, may collect information describing a process e.g. for the duration of a longer period of time, process this information further utilizing the control terminal and, subsequently, transmit the information to the storage equipment 13 for further distribution.

FIG. 3 is a block diagram showing a second preferred embodiment of the invention. The system of FIG. 3 highly resembles the system of FIG. 2. In the following, the embodiment of FIG. 3 will thus mainly be described in so far as it deviates from the case of FIG. 2.

Also in the case of FIG. 3, a process control network 3 is connected to an external communication network 5 via a one-way data transfer device 12 but, as distinct from the case of FIG. 2, no centralized storage equipment corresponding to that of FIG. 2 is used. Instead, one or more of computers 6 to 8 connected to the external communication network 5 serve as storage equipment. A computer 18 connected to the external communication network 5 via the Internet 10 may also serve as storage equipment. To enable this, messages to be transmitted from the process control network to the external communication network are to be assigned to the one or more computers 6 to 8 and/or 18 which is/are to receive the information. Computers that have been indicated to be the receivers of the information store all or at least some of the information contained in the messages in their memory. Users of the computers thus receive the desired information directly onto their own computers without having to transmit any inquiry messages. To enable this, e.g. a control terminal 4′ of an operator employs a computer program indicating what information is to be transmitted from the process control network, and to which computer 6 to 8 and/or 18.

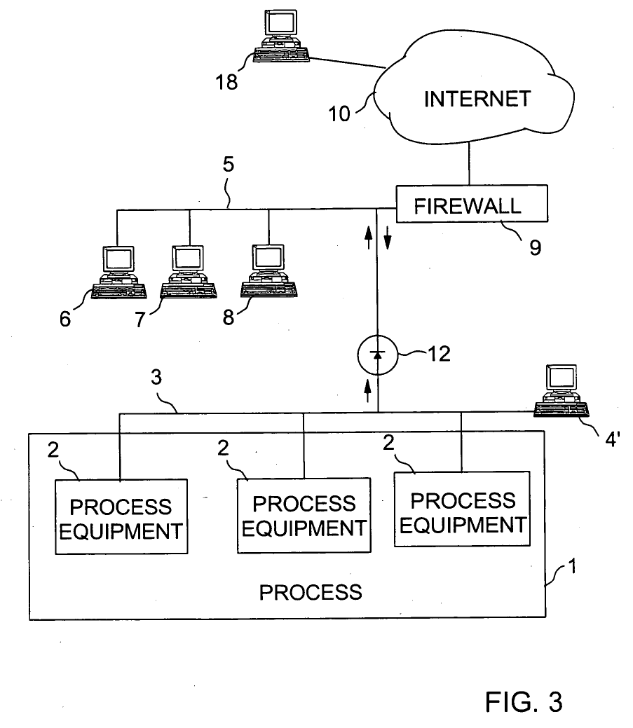

FIG. 4 is a block diagram showing a third preferred embodiment of the invention. The system of FIG. 4 highly resembles the system of FIG. 2. In the following, the embodiment of FIG. 4 will thus mainly be described in so far as it deviates from the case of FIG. 2.

As distinct from the case of FIG. 2, communication equipment 11 is connected to a process control network via a firewall 14. The firewall 14 is configured to filter messages to be transmitted in a first direction from the process control network 3 towards the communication equipment 11 in accordance with a predetermined filtering condition. Consequently, the firewall 14 may e.g. only allow messages containing predetermined contents (such as an identifier) to be transmitted from the process control network 3 towards the communication equipment 11. Alternatively, the firewall may prevent all messages containing predetermined contents (such as an identifier) from progressing from the process control network towards the communication equipment 11.

If the process control network employs a data transfer protocol requiring an acknowledgement to be delivered to the sender of a message, the firewall 14 or the communication equipment 11 of FIG. 4, e.g. through a one-way data transfer device 12 included therein, may take care of transmitting such an acknowledgement. Packet-switched data transfer protocols, for instance, typically require that a device that received a package should acknowledge that such a package has been received in order to inform the transmitting device that the package was transmitted successfully. However, the one-way data transfer device 12 prevents such acknowledgements from being delivered from the computers 6 to 8 or storage equipment connected to an external communication network to the equipment connected to the process network 3. In accordance with the invention, an acknowledgement may thus be generated and transmitted by the firewall 14 or, alternatively, by the one-way data transfer device 12 when these devices detect a message progressing from a process control network towards an external communication network.

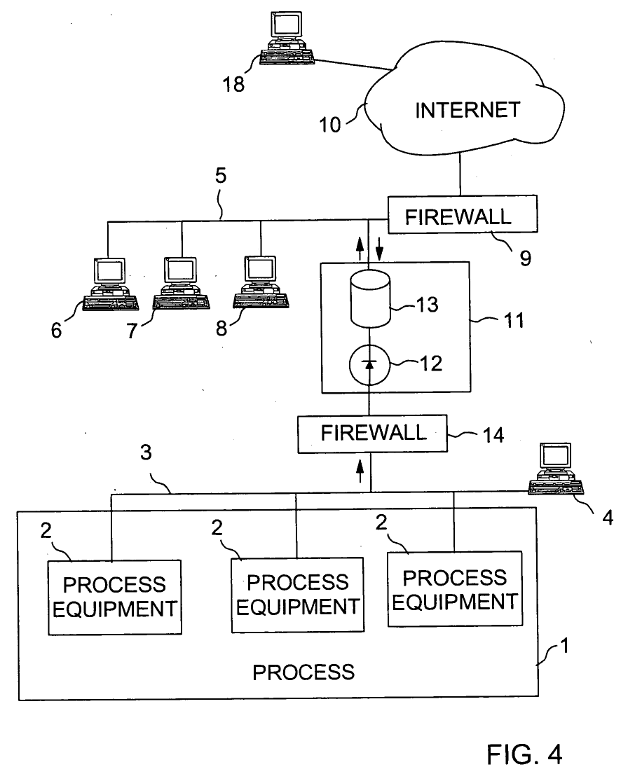

FIG. 5 illustrates a preferred embodiment of a one-way data transfer device. The one-way data transfer device 12′ of FIG. 5 may be used in place of the one-way data transfer device 12 in the embodiments of FIGS. 2 to 4 if the process control network employs a data transfer protocol requiring an acknowledgement. Blocks 15 to 17 of the data transfer device 12′ of FIG. 5 may be implemented by circuits, a computer program or a combination thereof.

The data transfer device 12′ shown in FIG. 5 includes a receiver 15 and a transmitter 16. These are configured to operate as in a repeater, i.e. the transmitter 16 further transmits, in a first direction towards an external communication network, those messages or packages that the receiver 15 has received from the process control network.

If the process control network employs a data transfer protocol requiring no acknowledgement, a second transmitter 17 shown in FIG. 5 is unnecessary. It is, however, assumed in the case of FIG. 5 that the process control network equipment requires acknowledgements to indicate that the transmitted messages and packages have been received successfully. To enable this, the one-way data transfer device 12′ of FIG. 5 also includes a second transmitter 17.

The input of the transmitter 17 is not connected to an external communication network but, instead, the receiver 15 gives the transmitter 17 an impulse for transmitting an acknowledgement. The information necessary for transmitting an acknowledgement is thus delivered from the receiver 15 to the transmitter 17, in which case the transmitter transmits the acknowledgement to the sender of the message or package received by the receiver 15. The transmitter 16, in turn, forwards the message or package towards the external communication network.

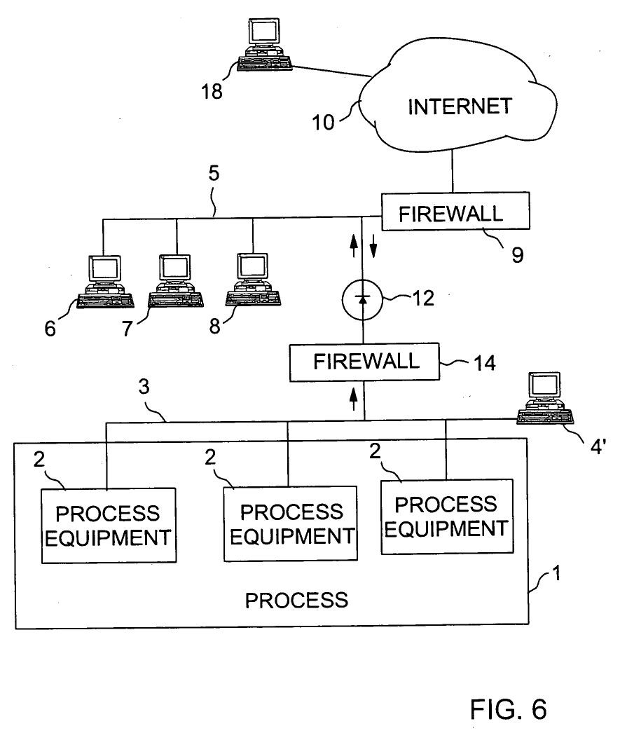

FIG. 6 is a block diagram showing a fourth preferred embodiment of the invention. The system of FIG. 6 highly resembles the system of FIG. 3. In the following, the embodiment of FIG. 6 will thus mainly be described in so far as it deviates from the case of FIG. 3.

As distinct from the case of FIG. 6, the one-way data transfer device 12 is connected to a process control network via a firewall 14. This firewall 14 corresponds to the firewall 14 described in connection with FIG. 4. The firewall 14 may thus only allow e.g. messages containing predetermined contents (such as an identifier) to be transmitted from the process control network 3 towards an external communication network 5. Alternatively, the firewall may prevent all messages containing predetermined contents (such as an identifier) from progressing from the process control network towards a communication network. If necessary, the firewall 14 may take care of acknowledgements as described in connection with FIG. 4.

It is to be understood that the above description and the related figures are only intended to illustrate the present invention. It will be obvious to one skilled in the art that the invention may be modified and varied in many different ways without deviating from the scope of the invention disclosed in the attached claims.

1. A system comprising:
a process control network having process equipment connected thereto for transmitting, through the process control network, messages describing at least the state of a process, and for receiving control commands through the process control network,
and an external communication network connected to the process control network via a one-way data transfer device allowing messages to be transmitted from the process control network to the external communication network and preventing messages from being transmitted from the external communication network to the process control network
the external communication network has storage equipment connected thereto, configured to store at least some of the information contained in the messages to be transmitted from the process control network to the external communication network.

2. A system as described in claim 1, wherein the storage equipment stores the information contained in the messages in a databank, from which desired information is retrievable by means of a computer having a data transfer connection to the external communication network.

3. A system as described in claim 1, wherein the storage equipment consists of a computer connected to the external communication network directly or through another communication network.

4. A system as claimed in claim 1, wherein the one-way data transfer device is connected to the process control network via a firewall which, in accordance with a pre-determined filtering condition, allows messages to be transmitted or prevents messages from being transmitted from the process control network to the external communication network via the one-way data transfer device.

5. A system as claimed in claim 4, wherein the firewall is configured to generate and transmit an acknowledgement to the process control network in response to a message received by the firewall from the process control network to be forwarded to the external communication network.

6. A system as claimed in claim 1, wherein the one-way data transfer device is configured to generate and transmit an acknowledgement to the process control network in response to a message transmitted from the process control network to the external communication network.

7. Communication equipment between two communication networks, said communication equipment comprising:
a one-way data transfer device allowing messages to be transmitted between the communication networks in a first direction, and preventing messages from being transmitted between the communication networks in a second direction, and
storage equipment which is configured to store, in a databank, information contained in messages transmitted in the first direction, and which, in response to an inquiry message being delivered from the second direction, retrieves the information indicated by the inquiry message from the databank and forwards the information in a response message.

8. Communication equipment as claimed in claim 7, wherein the communication equipment is configured to generate and transmit an acknowledgement in the second direction in response to a message received by the communication equipment from the first direction.

9. A method for forwarding information from a process control network, comprising
creating a databank wherein information contained in messages being delivered from a process control network via a one-way data transfer device is stored, and
conveying inquiry messages being delivered from an external communication network to the databank, wherefrom information requested for in the inquiry messages is retrieved and forwarded through the external communication network.
